(19) United States
(12) Patent Application Publication
(10) Pub. No.: US 2008/0042330 A1
(43) Pub. Date: Feb. 21, 2008

(54) DOOR CLOSER

(75) Inventors: Vesa Karkkainen, Joensuu (FI); Harri Juntunen, Joensuu (FI)

Correspondence Address: SMITH-HILL AND BEDELL, P.C., 16100 NW CORNELL ROAD, SUITE 220, BEAVERTON, OR, 97006, US

(73) Assignee: ABLOY OY, Joensuu (FI)

(21) Appl. No.: 11/841,389

(22) Filed: Aug. 20, 2007

(30) Foreign Application Priority Data
Aug. 21, 2006 (FI) 20065523

(51) Int. Cl. E05F 1/14

(52) U.S. Cl. 267/127

(57) ABSTRACT

A door closer includes a body formed with a cylinder and a piston system located in the cylinder and functionally connectable to the door. The piston system divides the cylinder into a first cylinder volume on a first side of the piston system and a second cylinder volume on a second side of the piston system. A spring located in the second cylinder volume. A flow channel formed in the body guides flow of fluid from the first cylinder volume to the second cylinder volume, and a control valve for regulates rate of fluid flow through the flow channel. A filter is positioned across the flow channel upstream of the control valve relative to flow of fluid through the flow channel from the first cylinder volume to the second cylinder volume. The filter presents a filter area greater than the cross-sectional area of the flow channel to incoming flow to the filter and presents a filter area substantially equal to the cross-sectional area of the flow channel to outgoing flow from the filter.

### CROSS-REFERENCE TO RELATED APPLICATION

This application claims priority under 35 USC 119 of Finnish Patent Application No. 20065523 filed Aug. 21, 2006.

### BACKGROUND OF THE INVENTION

1. Field of Technology

The invention relates to a door closer. The invention particularly relates to door closers filled with fluid such as oil.

2. Prior Art

The purpose of a door closer is to turn an open door to the closed position. The force required for turning is usually provided by a spring within the door closer that has stored energy when the door was opened. The spring moves a piston within the door closer that has a transmission link with the door closer's shaft arrangement. The shaft arrangement is further linked to a pulling device that forms a transmission link between the door and a fixed structure surrounding the door (such as the door frame).

If the speed of closing the door is not controlled, the door closer spring will move an open door to the closed position too rapidly with regard to user comfort. Therefore door closers usually contain oil that is allowed to move from one side of the door closer's piston system to the other side through at least one connecting channel. The flow in the connecting channel or channels is controlled using a control valve. The flow rate of the oil flowing in the connecting channel is regulated to a suitable level using the control valve. Regulation of the oil flow rate provides the desired speed of closing the door.

The door closing speed is usually adjusted when the door closer is installed on the door. Failure of the adjusted door closer to operate as desired constitutes a problem. A closing door may stop in a half-open position, or the closing movement may be jerky. Malfunctions with door closure may also take place sporadically, for example after 10 or 20 faultless closures.

The problem is caused by particles in the oil that have become released from the closer's internal parts. The particles can be aluminium, iron, deposits from the cast body etc. Particles tend to become released particularly in new, freshly installed door closers. The particles cause malfunctions particularly in the control valve. This means that several adjustments are required. Sporadic malfunctions may also take place in older installed door closers.

Patent publication GB 778850 describes a known method of preventing particles from being carried to the control valve. In this solution, a filter filters the oil flowing to the piston and the control valve, and the particles are collected in the filter. The filter is installed within the oil-filled internal chamber of the door closer, at the port to the flow channel. The problem with this solution is that impurities released by piston movement can freely reach the control valve. Furthermore, the filter's space requirement is relatively large, which means that it must be installed at a spacious location.

### SUMMARY OF THE INVENTION

The purpose of the invention is to eliminate the problems presented above.

In accordance with a first aspect of the invention there is provided a door closer comprising a body formed with a cylinder, a piston system located in the cylinder, said piston system having first and second sides and dividing the cylinder into a first cylinder volume on the first side of the piston system and a second cylinder volume on the second side of the piston system, said piston system being functionally connectable to the door, and a spring located in the second cylinder volume, wherein the body is formed with a flow channel for guiding flow of fluid from the first cylinder volume to the second cylinder volume, and the door closer further comprises a control valve for regulating rate of fluid flow through said flow channel, and a filter positioned across the flow channel upstream of the control valve relative to flow of fluid through the flow channel from the first cylinder volume to the second cylinder volume, and wherein the filter presents a filter area greater than the cross-sectional area of the flow channel to incoming flow to the filter and presents a filter area substantially equal to the cross-sectional area of the flow channel to outgoing flow from the filter.

In accordance with a second aspect of the invention there is provided door closer comprising a body formed with a cylinder, a piston system located in the cylinder, said piston system having first and second sides and dividing the cylinder into a first cylinder volume on the first side of the piston system and a second cylinder volume on the second side of the piston system, said piston system being functionally connectable to the door, and a spring located in the second cylinder volume, wherein the body is formed with first and second flow channels for guiding flow of fluid between the first cylinder volume to the second cylinder volume, and the door closer further comprises a first control valve for regulating rate of fluid flow through said first flow channel, a second control valve for regulating rate of fluid flow through said second flow channel, and a filter positioned across one of said flow channels, and wherein the filter presents a filter area greater than the cross-sectional area of said one flow channel to incoming flow to the filter and presents a filter area substantially equal to the cross-sectional area of said one flow channel to outgoing flow from the filter.

In accordance with a third aspect of the invention there is provided a door closer comprising a body formed with a cylinder, a piston system located in the cylinder, said piston system having first and second sides and dividing the cylinder into a first cylinder volume on the first side of the piston system and a second cylinder volume on the second side of the piston system, said piston system being functionally connectable to the door, and a spring located in the second cylinder volume, wherein the door closer defines channels for guiding flow of fluid from the first cylinder volume to the second cylinder volume and vice versa depending on movement of the piston system, said channels including a closing flow channel formed in the body for guiding flow of fluid from the first cylinder volume to the second cylinder volume, and the door closer further comprises a control valve for regulating rate of fluid flow through said closing flow channel, and a filter positioned across the closing flow channel upstream of the control valve relative to flow of fluid through the closing flow channel from the first cylinder volume to the second cylinder volume, and wherein the filter presents a filter area greater than the cross-sectional area of the closing flow channel to incoming flow to the filter and presents a filter area substantially equal to the cross-sectional area of the closing flow channel to outgoing flow from the filter.

A preferred embodiment of the invention is a door closer that comprises a filter fitted across the flow channel to filter the fluid flowing to the control valve. The flow channel is within the door closer body and guides the flow of fluid from a first side of the piston system to a second side. The control valve is located in connection with the flow channel. The filter is arranged so that the incoming flow to the filter is allowed to pass through a filter area greater than the cross-sectional area of the flow channel, and the outgoing flow from the filter is allowed to pass through a filter area equal to the cross-sectional area of the flow channel. In a preferred embodiment of the invention, the filter arrangement has sufficient filtering capacity without blocking the filter. The filter is also fitted in the door closer body in a space-saving manner.

### BRIEF DESCRIPTION OF THE DRAWINGS

In the following, an embodiment of the invention is described in more detail by reference to the enclosed drawings, where

FIG. 1 illustrates a door closer embodying the invention while the door is open,

FIG. 2 illustrates the example of FIG. 1 while the door is closed,

FIG. 3 illustrates the example of FIG. 1 from another angle,

FIG. 4 illustrates a filter in a door closer embodying the invention in the static state,

FIG. 5 illustrates the filter of FIG. 4 in a state under flow pressure,

FIG. 6 illustrates another filter in a door clower embodying the invention in the static state,

FIG. 7 illustrates the filter of FIG. 6 in a state under flow pressure,

FIG. 8 illustrates an example of a filter, and

FIG. 9 illustrates another example of a filter.

### DETAILED DESCRIPTION

The purpose of the figures is to illustrate the structure and operation of an embodiment of the invention. Thus the figures do not illustrate a complete door closer, all of the parts potentially contained in the door closer, or different types of door closers. However, the structures contained in a door closer are known to a person skilled in the art.

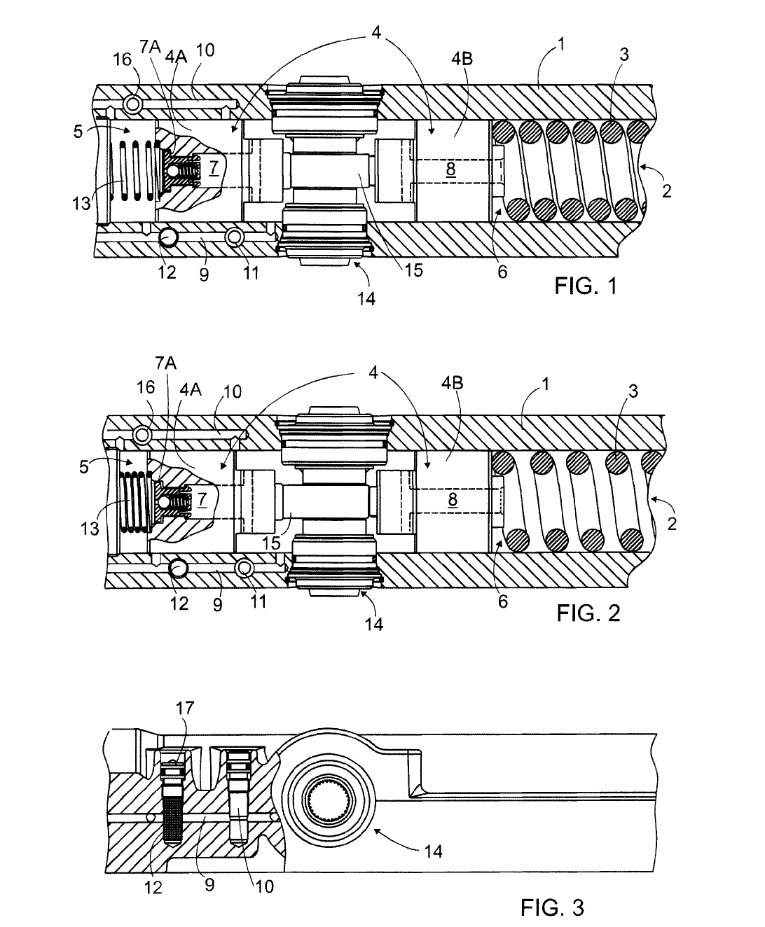

FIG. 1 illustrates an example of a door closer embodying the invention while the door is open, and FIG. 2 illustrates the same example while the door is closed. Furthermore, FIG. 3 illustrates the same example of a door closer viewed from another angle.

The door closer illustrated in FIGS. 1 to 3 comprises a body 1 in which a cylinder 2 to be filled with fluid is arranged. A spring 3 and a piston system 4 are located in the cylinder. The piston system divides the cylinder into the cylinder volume 5 on the first side of the piston system and the cylinder volume 6 on the second side of the piston system. The piston system can be functionally linked to the door. The spring 3 is within the cylinder volume 6 on the second side of the piston system.

The door closer further comprises a flow arrangement 7, 8, 9, 10 to guide the flow of fluid from the cylinder volume 5 on the first side of the piston system to the cylinder volume 6 on the second side of the piston system and vice versa depending on the movement of the piston system 4. The flow arrangement comprises at least one flow channel 9 located in the body 1 to guide the flow of fluid from the cylinder volume 5 on the first side of the piston system to the cylinder volume 6 on the second side. The door closer further comprises a control valve 11 located in connection with the flow channel 9 to regulate the rate of fluid flow.

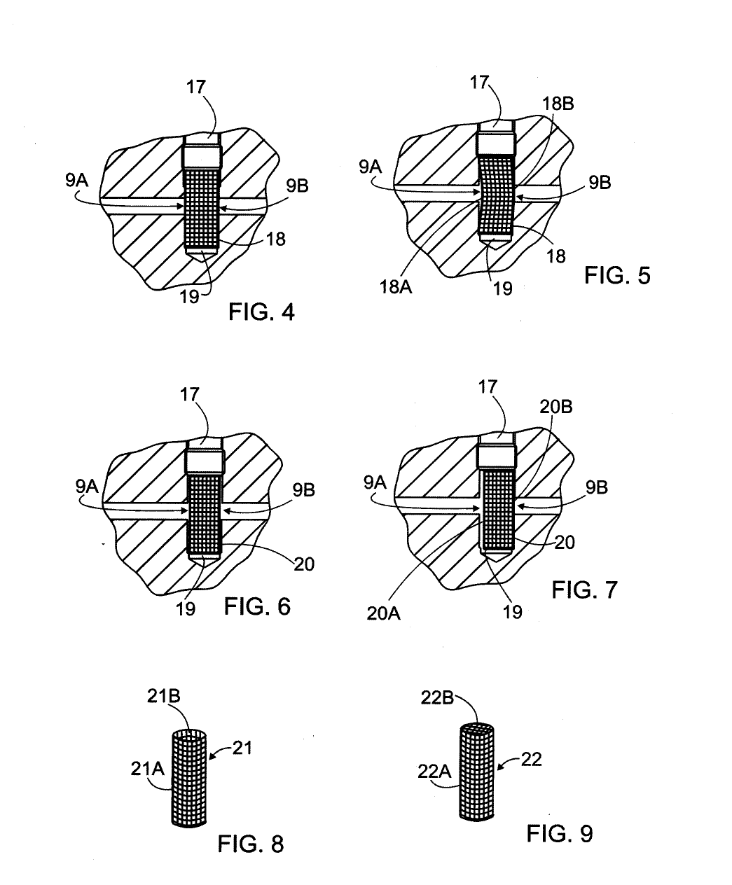

A filter 12 is fitted across the door closer's flow channel 9 to filter the fluid flowing to the control valve 11. The filter is arranged so that the incoming flow to the filter is allowed to pass through a filter area greater than the cross-sectional area of the flow channel 9, and the outgoing flow from the filter is allowed to pass through a filter area equal to the cross-sectional area of the flow channel. See FIGS. 4 to 7.

FIG. 1 illustrates the state of the door closer while the door is open. The door closer installed in connection with a door is functionally linked to the door and its support structure (such as the door frame). Turning of the door turns the shaft arrangement 14 within the door closer, which in turn moves the piston system 4. It can thus be noted that the piston system 4 is functionally linked to the door. While the door is open, the spring 3 is in a compressed state within the cylinder volume 6 on the second side of the piston system, pressed by the piston part 4B.

The shaft arrangement in the example of FIGS. 1 to 3 is a camshaft arrangement. The shaft arrangement 14 comprises a cam structure 15 that is in contact with the piston parts 4A and 4B in the piston system. Door closers can be categorised in accordance with the shaft arrangement employed. Therefore a door closer according to the example is usually called a cam closer. Other types of shaft arrangements and piston systems also exist, such as a shaft arrangement comprising a cogwheel and a piston linked to it. In addition to cam closers, the invention may be applied for use in other types of door closers.

In the situation in FIG. 1, the compressed spring 3 pushes the piston part 4B, which turns the entire shaft arrangement through the cam structure 15 and causes the open door to try to turn to the closed position. The cam structure also pushes the piston part 4A on the other side of the shaft arrangement when the cam in the cam structure turns towards the piston part 4A. Because the cylinder 2 is filled with fluid, normally oil, the movement of the piston system causes the fluid to try to flow from the cylinder volume 5 on the first side of the piston system to the cylinder volume 6 on the second side. Flow will initially take place through channel 9 and channel 8. When the door is almost closed (for example, when the door is open at an angle from 0 to 10 degrees), the piston part 4A has closed the channel 9, and the flow shifts to channel 10 and channel 8. The channel 10 has a control valve 16 for regulating the fluid flow rate.

The piston part 4A has a directional valve 7A that prevents fluid flow when the door is being closed. However, if the fluid pressure increases to a certain limit, a non-return valve that may be included in the directional valve will allow the fluid to flow to channel 7 and further to channel 8.

FIG. 2 illustrates a situation in which the door is closed. In this situation, the spring 3 has pressed the piston system so that the cylinder volume 5 on the first side of the piston system is at its minimum, and the cylinder volume 6 on the second side is at its maximum. When the door is being opened, the cam in the cam structure 15 within the shaft arrangement turns to push the piston part 4B within the piston system 4, which in turn presses the spring 3 towards the compressed state. A weaker spring 13 within the cylinder volume on the first side ensures that the piston part 4A within the piston system will follow the turning of the cam structure 15. When the door is being opened, the fluid tries to flow from the cylinder volume 6 on the second side of the piston system to the volume 5 on the first side through channel 8 and channel 7. The directional valve 7A in the channel 7 allows the fluid to flow in this direction. The flow capacity of the channel 7 and the directional valve 7A is substantially higher than that of the channels 9 and 10 within the body, so it can be noted that in practice, the flow goes through the channel 7 when the door is being opened.

The flow arrangement 7, 8, 9, 10 illustrated in the figures represents a potential flow arrangement. Other flow arrangements can also be implemented. For example, there may be only one channel in the body, or alternatively, there may be at least three channels in the body. The channel system 7, 8 implemented in the piston system can be replaced by a channel system arranged in the body that provides similar function. Each of the channels 9, 10 that are intended to guide the fluid flow from the cylinder volume 5 on the first side of the piston system to the cylinder volume on the second side should preferably be fitted with a control valve 11, 16. In a door closer according to the invention, at least one such channel is fitted with a filter 12 across the channel that prevents impurities from reaching the control valve. The impurities constitute particles released from the internals of the door closer. Impurities cause malfunctions in the control valve in particular and can even block the channel at the control valve.

FIG. 3 illustrates the channel 9, as well as the control valve 11 and the filter 12 located in connection with it, viewed from the side. The filter is fitted in the space across the channel 9. The figure shows that a holding part 17 keeps the filter 12 in said space. The holding part may be a separate part, or the filter 12 and the holding part 17 may be integrated.

FIGS. 4 and 5 illustrate an embodiment of the filter 18. The filter 18 is a circular cylinder, the mesh jacket of which constitutes a filtering structure. The filter is also flexible and therefore bends under fluid flow pressure. The filter 18 is in a space 19 formed in the body 1 across the flow channel 9. The filter comprises a first filter layer 18A and a second filter layer 18B that are connected to each other. The first filter layer 18A constitutes a filtering layer for the flow coming into the filter—that is, the first filter layer is against the channel opening 9A through which the fluid flows into the filter and the transverse space 19. The second filter layer 18B constitutes a filtering layer for the flow going out of the filter—that is, the second filter layer is against the channel opening 9B through which the fluid flows out of the filter 18 and the transverse space 19. The filter is dimensioned so that there is no gap between the filter 18 and the walls of the space 19. It is naturally also possible that there is a small gap.

FIG. 4 illustrates the filter in the static state—that is, with no fluid flow in the channel 9. FIG. 5 illustrates the filter in the operating state, with fluid flowing in the channel 9. In the operating state, the filter 18 is arranged to be pressed by the fluid flow pressure against the downstream wall of the space 19 in which there is the flow channel outlet 9B, and as a consequence of this pressure, the second filter layer 18B settles tightly against the flow channel outlet 9B. The incoming flow to the filter is allowed to pass through the area of the first filter layer 18A of the filter that is greater than the cross-sectional area of the flow channel 9 because the filter is flexible.

FIGS. 6 and 7 illustrate another embodiment of the filter. Also in this embodiment, the filter 20 is a circular cylinder, the mesh jacket of which constitutes a filtering structure. The filter 20 is rigid and therefore maintains its shape under fluid flow pressure. The filter 20 is in the space 19. There is a gap between the filter 20 and the walls of the space 19. Similar to the embodiment of FIGS. 4 and 5, the filter 20 comprises a first filter layer 20A and a second filter layer 20B that are connected to each other, with the first filter layer 20A constituting a filtering layer for the flow coming into the filter and the second filter layer 20B constituting a filtering layer for the flow going out of the filter.

In the operating state, the filter 20 is pressed by the fluid flow pressure against the downstream wall of the space 19 in which there is the flow channel outlet 9B, and as a consequence of this pressure, the second filter layer 20B settles tightly against the flow channel outlet 9B; the incoming flow to the filter is allowed to pass through the area of the first filter layer 20A of the filter that is greater than the cross-sectional area of the flow channel 9 because the filter is pressed against the flow channel outlet 9B and therefore the gap between the filter 20 and the walls of the space is on the side of the flow channel inlet 9A.

FIG. 8 illustrates a filter 21 that is a circular cylinder with both ends 21B being open. The jacket 21A is made of mesh of a suitable size. FIG. 9 illustrates another example of a circular cylindrical filter 22 with one of the ends 22B being closed, resulting in that the filter jacket 22A and the closed end 22B form a cup-like shape. It is also possible that both ends of the circular cylindrical filter are closed or that there is at least one support structure to support the jacket 21A, 22A on the inside of the jacket. The closed ends are actually support structures but they are located at the ends of the cylinder.

Other structures of the filter are also possible. In place of a circular cylinder, the cylinder jacket may be elliptical, resulting in an elliptical cylinder. The basic shape of the filter can also be a rectangular prism in which two opposite sides are either open or closed. It is thus clear that similar to the circular cylinder examples presented above, elliptical cylinders and rectangular prisms may also have closed or open ends or potential support structures. The filter is made of a material suitable for the purpose, such as a metal or alloy. It is preferable that the shape of the transverse space 19 is arranged to be substantially similar to the shape of the filter.

As can be noted from the previous examples, the filter will not require much space when it is installed in a space within the body that crosses the flow channel. This does not require any increases to the size of the door closer, such as its length. A filter installed this way is therefore space-saving. Even though the flow channel is usually relatively small (the channel diameter is normally approx. 2.3 to 3.5 mm), a transversely installed filter will not become blocked. This is due to the fact that the area of the first filter layer through which the incoming flow to the filter goes is greater than the cross-sectional area of the channel. (The diameter of a circular cylinder filter is 5 to 10 mm, for example.) Thus the filter arrangement has sufficient capacity to prevent blockage of the filter due to impurities. If the first filter layer within the filter becomes blocked, which is uncommon, the transverse space and the second filter layer still have remaining capacity that allows the filter to operate as desired.

The filter filters all of the fluid, normally oil, that goes through the control valve. Thus the internals of the door closer, which are the sources of impurity particles, are not located between the filter and the control valve. Impurities cause particular inconvenience in door closers intended to close a door slower than normally and/or in door closers in which the fluid pressure is high and the fluid volume is low (such as cam closers). High pressure releases more particles from the internals of the closer, and in a slowly closing door, even a small impurity in the door closer control valve will cause an observable malfunction.

It will be appreciated that the invention is not restricted to the particular embodiments that have been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A door closer comprising:
a body formed with a cylinder,
a piston system located in the cylinder, said piston system having first and second sides and dividing the cylinder into a first cylinder volume on the first side of the piston system and a second cylinder volume on the second side of the piston system, said piston system being functionally connectable to the door, and
a spring located in the second cylinder volume,
wherein the body is formed with a flow channel for guiding flow of fluid from the first cylinder volume to the second cylinder volume,
and the door closer further comprises:
a control valve for regulating rate of fluid flow through said flow channel, and
a filter positioned across the flow channel upstream of the control valve relative to flow of fluid through the flow channel from the first cylinder volume to the second cylinder volume,
and wherein the filter presents a filter area greater than the cross-sectional area of the flow channel to incoming flow to the filter and presents a filter area substantially equal to the cross-sectional area of the flow channel to outgoing flow from the filter.

2. A door closer according to claim 1, wherein the filter comprises first and second filter layers that are connected to each other, the first filter layer is positioned to filter fluid as it enters the filter and the second filter layer is positioned to filter fluid as it leaves the filter.

3. A door closer according to claim 2, wherein the body is formed with a space that extends across the flow channel and the filter comprises a filter element located in said space.

4. A door closer according to claim 3, wherein said space has a downstream wall formed with an outlet opening by which the flow channel leads to the control valve and pressure of fluid against the filter element forces the second filter layer tightly against the downstream wall.

5. A door closer according to claim 3, wherein said space has an upstream wall formed with an inlet opening by which the flow channel guides fluid from the first chamber to said space and pressure of fluid against the filter element forces the first filter layer away from the upstream wall.

6. A door closer according to claim 3, wherein the filter element is flexible.

7. A door closer according to claim 3, wherein said space has a downstream wall formed with an outlet opening by which the flow channel leads to the control valve, said space has an upstream wall formed with an inlet opening by which the flow channel guides fluid from the first chamber to said space, the filter element is substantially rigid and is located in said space with clearance between said downstream and upstream walls, and pressure of fluid against the filter element forces the first filter layer away from the upstream wall and forces the second filter layer tightly against the downstream wall.

8. A door closer according to claim 3, wherein the filter element is shaped as a circular or elliptical cylinder.

9. A door closer according to claim 8, wherein at least one end of the filter element is open.

10. A door closer according to claim 8, wherein at least one end of the filter element is closed.

11. A door closer according to claim 3, wherein the filter element comprises an outer jacket and a support structure within the outer jacket.

12. A door closer according to claim 3, wherein the filter element is shaped as a substantially rectangular prism with two opposite sides.

13. A door closer according to claim 12, wherein at least one side of the filter is closed.

14. A door closer according to claim 12, wherein at least one side of the filter is open.

15. A door closer according to claim 3, comprising a holding part for retaining the filter element in said space.

16. A door closer according to claim 15, wherein the holding part is integral with the filter element.

17. A door closer according to claim 1, wherein the body is formed with a chamber upstream of the control valve and the filter comprises first and second filter layers that are located in the chamber and are connected to each other, the first filter layer is positioned to filter fluid as it enters the chamber and the second filter layer is positioned to filter fluid as it leaves the chamber.

18. A door closer according to claim 17, wherein said flow channel has a central axis, the chamber is substantially cylindrical and has a central axis that is transverse to the central axis of said flow channel, and the filter comprises a substantially cylindrical filter element disposed in said chamber.

19. A door closer comprising:
a body formed with a cylinder,
a piston system located in the cylinder, said piston system having first and second sides and dividing the cylinder into a first cylinder volume on the first side of the piston system and a second cylinder volume on the second side of the piston system, said piston system being functionally connectable to the door, and
a spring located in the second cylinder volume,
wherein the body is formed with first and second flow channels for guiding flow of fluid between the first cylinder volume to the second cylinder volume,
and the door closer further comprises:
a first control valve for regulating rate of fluid flow through said first flow channel,
a second control valve for regulating rate of fluid flow through said second flow channel, and
a filter positioned across one of said flow channels,
and wherein the filter presents a filter area greater than the cross-sectional area of said one flow channel to incoming flow to the filter and presents a filter area substantially equal to the cross-sectional area of said one flow channel to outgoing flow from the filter.

20. A door closer comprising:
a body formed with a cylinder,
a piston system located in the cylinder, said piston system having first and second sides and dividing the cylinder into a first cylinder volume on the first side of the piston system and a second cylinder volume on the second side of the piston system, said piston system being functionally connectable to the door, and
a spring located in the second cylinder volume,
wherein the door closer defines channels for guiding flow of fluid from the first cylinder volume to the second cylinder volume and vice versa depending on movement of the piston system, said channels including a closing flow channel formed in the body for guiding flow of fluid from the first cylinder volume to the second cylinder volume,
and the door closer further comprises:
a control valve for regulating rate of fluid flow through said closing flow channel, and
a filter positioned across the closing flow channel upstream of the control valve relative to flow of fluid through the closing flow channel from the first cylinder volume to the second cylinder volume,
and wherein the filter presents a filter area greater than the cross-sectional area of the closing flow channel to incoming flow to the filter and presents a filter area substantially equal to the cross-sectional area of the closing flow channel to outgoing flow from the filter.
